(19) United States
(12) Patent Application Publication
(10) Pub. No.: US 2006/0222975 A1
(43) Pub. Date: Oct. 5, 2006

(54) Integrated optical metrology and lithographic process track for dynamic critical dimension control

(75) Inventors: Chih-Ming Ke, Hsinchu City (TW); Shing-Shen Yu, Hsinchu (TW); Yu-Hsi Wang, Hsinchu City (TW); Tsai-Sheng Gau, Hsinchu City (TW); Jacky Huang, Zhubei City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd.

(21) Appl. No.: 11/097,737

(22) Filed: Apr. 2, 2005

(51) Int. Cl. G03B 27/00; G03C 5/00

(52) U.S. Cl. 430/30; 355/18; 430/330; 430/311

(57) ABSTRACT

A method and apparatus for improving a yield and throughput of a lithographic process track, the method including providing a first resist layer on a first process wafer; forming a first resist pattern in the first resist layer including a heating process according to a first temperature profile wherein the heating process comprises a plurality of temperature controllable heating zones; producing and collecting scattered light spectra from the first resist pattern processing the scattered light spectrum to obtain 3-dimensional information including first resist pattern critical dimensions; determining a second temperature profile for performing the heating process to achieve targeted resist pattern critical dimensions including a second resist pattern on a second process wafer; and, forming the second resist pattern dimensions including the heating process according to the second temperature profile.

### FIELD OF THE INVENTION

This invention generally relates to lithographic processes and more particularly to resist baking and development processes in an integrated circuit manufacturing process including an integrated temperature control and optical metrology system for achieving dynamic and real-time adjustments in a resist baking process to achieve improved critical dimension (CD) and critical dimension uniformity (CDU) control in a lithography process including increased wafer throughput.

### BACKGROUND OF THE INVENTION

Since the introduction of semiconductor devices, the size of semiconductor devices has been continuously shrinking, resulting in smaller semiconductor chip size and increased device density. One of the limiting factors in the continuing evolution toward smaller device size and higher density has been the increasingly stringent requirements placed on the accuracy and resolution of lithographic patterning processes. Various methods have been implemented to increase the critical dimension (CD) resolution performance of resists and to increase within wafer critical dimension uniformity (CDU) in lithographic patterning processes.

Typically a resist layer is applied to a semiconductor wafer process surface, followed by exposure of the resist through a mask. A baking process, referred to as post-exposure bake (PEB) is then carried out to alter physical properties of the resist including initiating chemical reactions in the resist to render the resist soluble in a subsequent development process. The temperature and time period of the PEB process can be critical to CD control of subsequently developed photoresist profiles. Temperatures must typically be controlled to within about 0.1° C. to prevent undesirable CD variations in the subsequently developed resist to form a circuitry pattern.

As semiconductor device CD's are scaled down to below about 100 nm, small nanometer sized variations in a resist profile make up an increasingly larger percentage of the CD, thereby increasing the level of CD error. For example, two parameters known as bias and tolerance are frequently used to define CD requirements in the semiconductor processing art. CD Bias is the difference in lateral dimension between the patterned image and the mask image. CD uniformity is a measure of the statistical distribution of CD bias values (e.g., 3×sigma) that characterizes the uniformity of patterning. For example, in etching polysilicon gate structures, the gate length determines the channel length and the acceptable electronic functioning of a transistor making gate CD uniformity critical in the gate formation process. Nonuniform resist patterning may adversely affect the manufacturing process as well as the reliability of integrated circuits in several ways. For example, unacceptable within-wafer CD variations require that the lithographic process be repeated, which lowers wafer throughput and increases production costs.

In prior art processes, following resist development, an after development inspection process (ADI) may be carried out in-line by scanning electron microscope (SEM) or may be carried out off-line by transmission electron microscopy (TEM). For example SEM processes obtain surface CD information, but are not able to obtain profiles of developed resist patterns. TEM, on the other hand, requires time consuming and sample destructive preparation processes to prepare a sample including a profile (cross-section) of the resist in order to ascertain the efficacy of a PEB and/or development process with respect to resist profiles.

Another limitation in prior art processes, is that once a deficiency in a PEB process has been determined, time consuming calibration and adjustment of a heating plate is required to alter the PEB process temperature, frequently involving a trial and error approach. For example, a process wafer throughput flow is frequently interrupted to carryout iterative PEB temperature adjustments on a test wafer followed by an ADI process, and so forth, until acceptable resist CD is achieved. Unfortunately, several variables may make previously determined PEB process temperature profiles unacceptable in producing desired CD's, including environmental variables, hardware variables, and variables specific to the line density and pitch of a particular circuitry pattern. As such, achieving acceptable resist pattern CD's is frequently time consuming and costly, requiring frequent reworking of process wafers.

Thus, there is a need in the integrated circuit manufacturing art for an improved resist metrology process as well as an improved method for adjusting lithography process variables to quickly and accurately determine process wafer resist profiles and accordingly adjust lithography process variables to improve CD and within wafer CD uniformity while improving a wafer throughput.

It is therefore an object of the invention to provide an improved resist metrology process as well as an improved method for adjusting lithography process variables to quickly and accurately determine process wafer resist profiles and accordingly adjust lithography process variables to improve CD and within wafer CD uniformity while improving a wafer throughput, in addition to overcoming other shortcomings and deficiencies of the prior art.

### SUMMARY OF THE INVENTION

To achieve the foregoing and other objects, and in accordance with the purposes of the present invention, as embodied and broadly described herein, the present invention provides a method and apparatus for improving a yield and throughput of a lithographic process track.

In a first embodiment, the method includes providing a first resist layer on a first process wafer; forming a first resist pattern in the first resist layer including a heating process according to a first temperature profile wherein the heating process comprises a plurality of temperature controllable heating zones; producing and collecting scattered light spectra from the first resist pattern; processing the scattered light spectrum to obtain 3-dimensional information including first resist pattern critical dimensions; determining a second temperature profile for performing the heating process to achieve targeted resist pattern critical dimensions including a second resist pattern on a second process wafer; and, forming the second resist pattern dimensions including the heating process according to the second temperature profile.

These and other embodiments, aspects and features of the invention will be better understood from a detailed description of the preferred embodiments of the invention, which are further described below in conjunction with the accompanying Figures.

### BRIEF DESCRIPTION OF THE DRAWINGS

FIG. 1 is a schematic representation of an exemplary lithography process track according to an embodiment of the present invention.

FIG. 2A is a top view of an exemplary heating plate having exemplary heating cells according to an embodiment of the invention.

FIG. 2B is a top view of a portion of an exemplary semiconductor process wafer surface showing exemplary heating zones according to an embodiment of the present invention.

FIG. 3A is a top view of a portion semiconductor process wafer including a resist pattern and probing area according to an embodiment of the invention.

FIG. 3B is a cross sectional view of a portion of a semiconductor process wafer including a resist pattern undergoing optical metrology according to an embodiment of the invention.

FIG. 4 is an exemplary plot of data showing an exemplary model functional relationship between variation of mean critical dimension of a patterned resist layer and a heating zone temperature according to an embodiment of the present invention.

FIG. 5 is a process flow diagram including several embodiments of the method of the present invention.

### DETAILED DESCRIPTION OF THE PREFERRED EMBODIMENTS

Although the system and method of the present invention are explained in exemplary implementation with respect to achieving CD accuracy and uniformity of a patterned resist layer in an integrated circuit manufacturing process, it will be appreciated that the invention may be adapted for application to micro-engineered machine (MEM) processes or other processes where resist patterns with critical dimensions (CD's) of less than about 0.25 microns are formed for subsequent dry etching according to the patterned resist layer.

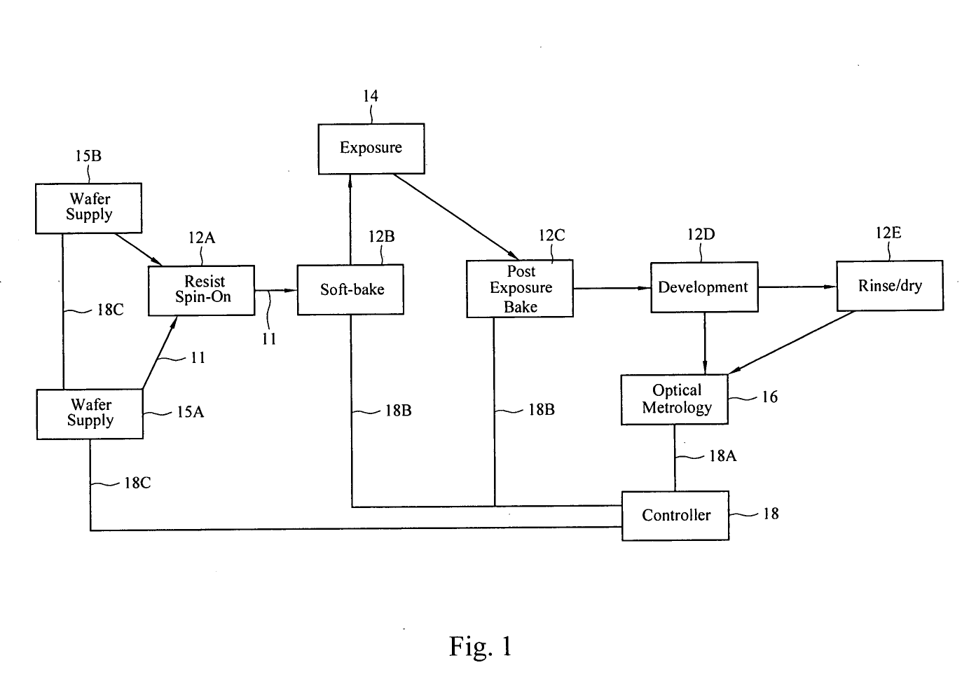

Referring to FIG. 1, in an exemplary implementation of the present invention, an exemplary lithography process track is schematically represented, showing a conventional resist spin-on station 12A, a soft-bake station 12B, a post exposure bake (PEB) station 12C, a development station 12D, and a rinse/dry station 12E. Arrows e.g., 11 indicate an exemplary process flow on the lithography process track including transfer to an exposure station 14 e.g., stepper for exposing the process wafer resist to radiant energy following the softbake process at station 12B and before the PEB process at station 12C. Conventional wafer supply racks e.g., 15A and 15B for queuing and supplying process wafers to the lithographic process track, e.g., production process wafers or buffer wafers including calibration (test) wafers, respectively, are provided. The lithographic process track including wafer supply racks e.g., 15A and 15B is preferably in communication with a controller 18 e.g., communication lines 18C, for automated integrated control of the lithographic process flow as explained further below.

In an important aspect of the invention, an optical metrology station 16 including a conventional spectrometer for collecting spectra of scattered light in digital format from the resist, as further explained below, is provided downstream of the development station 12D or downstream of the rinse/dry station 12E. For example, the optical metrology station 16 may include conventional spectrometers for probing, detecting, and collecting scattered light such as ellipsometers or reflectometers as are known in the art. A conventional controller 18, preferably including one or more dedicated processors for processing digital information according to processing algorithms as well as conventional storage media, is provided in communication (e.g., controller command and instrument response) with the optical metrology station 16 (spectrometer) e.g., communication line 18A. The collected spectra may be received, stored, and processed in response to controller 18 commands. It will be appreciated the controller may be incorporated in the optical metrology station 16, and that the optical metrology station 16 may be incorporated into the lithographic process track. Both wire and wireless communication will be understood to be included in the term “communication” as used herein and as a represented by communication lines, e.g., 18A.

According to an important aspect of the invention communication between the controller 18, e.g., and the heating stations, e.g., 12B and 12C, preferably including at least the PEB station 12C, is provided e.g., via communication line 18B. It will be appreciated that more heating stations may be provided in communication with the controller 18 for sending a temperature status and responding to heating zone temperature setting commands. In another aspect of the invention the heating stations e.g., 12B and 12C, are preferably heating plates that have a plurality of heating cells including conventional heating elements and sensors, e.g. resistive heating elements and associated thermocouples or RTD sensors, associated with one or more heating cells. The heating cells may be selected and grouped by the controller 18 according to programmed instructions into clusters of any geometry to form heating plate heating zones.

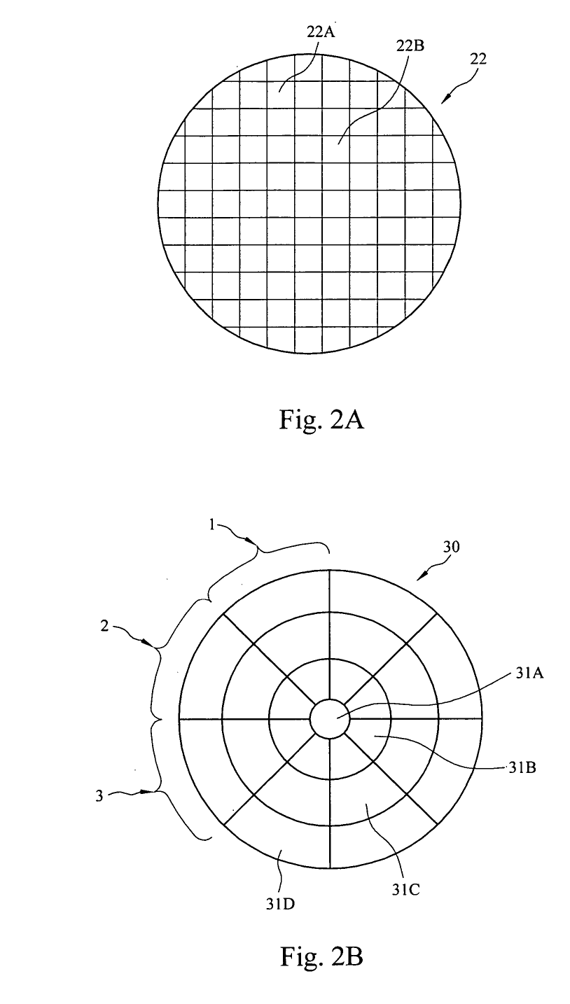

For example referring to FIG. 2A, is shown a top view of an exemplary heating plate 22, having a plurality of heating cells e.g., 22A, and 22B, preferably arranged to fully extend to heat a process wafer diameter e.g., a wafer backside placed in contact with the heating cells in a lithographic, e.g., PEB heating process. Each of the heating cells, e.g., 22A and 22B preferably include conventional heating elements and temperature sensors (e.g., thermocouples, RTD's) in communication with controller 18 for sensing and controlling the temperature of each of the heating cells. It will be appreciated that the controller 18 may provide PID (proportional, integral, and differential) control or that one or more secondary PID controllers (not shown) may be provided in communication between the controller 18 and the heating cells e.g., 22A and 22B to provide secondary PID temperature control. It will also be appreciated that control and processing functions of controller 18 may be incorporated into the optical metrology station 16 and that communication and control functions between the lithographic process track including the heating stations 12B, 12C and the optical metrology station 16 may be accomplished by a distributed wire or wireless network where each of the lithographic processing stations include relevant portions of control and communication functions depending on the status and results of upstream and/or downstream processing stations to control the lithographic track process flow.

According to an embodiment of the invention, a plurality of the heating cells e.g., 22A and 22B may be selected or grouped into any geometry of adjacent heating zones as shown below in FIG. 2B corresponding to wafer heating zones. The geometry of the heating zones including heating cells on the heating plate and corresponding wafer heating zones may be selected according to interactive or programmed instructions by the controller 18 to group different pluralities of the heating cells into adjacent heating zone geometries.

Referring to FIG. 2B, in operation, selected portions of a test or production process wafer e.g., 30 are probed in selected areas (heating zones) of the wafer surface corresponding to heating plate heating zones. It will be appreciated that information of the orientation of the process wafer 30 is known and correlated with a heating plate heating zone area. For example, exemplary heating zone areas on the process wafer 30 are shown, which correspond to heating zones on a heating plate, preferably at the PEB station 12C for carrying out the PEB process. For example, concentrically shaped heating zones e.g., 31A, 31B, 31C, and 31D, are shown which may be further divided into selected adjacent portions e.g., 1, 2, 3 etc.

Referring back to FIG. 1, in exemplary operation, following spin coating a process wafer with resist at station 12A, and followed by a soft-bake process at station 12B to drive off excess solvent an impart stability to the resist, a process wafer is transferred to a conventional photolithographic exposure station 14, for example a conventional stepper for exposing the resist through a reticule onto individual die portions on the process wafer surface. Following exposure, the process wafer is transferred to the PEB station 12C of the lithography process track. Following a PEB process using a pre-a determined temperature profile corresponding to a process temperature for each of the heating cells and/or heating zones (e.g., temperatures from 80° C. to 160° C.), the process wafer is transferred to a development station 12D. At the development station, a developing process is carried out to develop or dissolve soluble portions of the resist, for example, a positive chemically amplified resist where photo acid generators (PAG) in the resist generate an acid which is catalyzed in the PEB process to render resist portions soluble in the developer solution. A conventional rinse, e.g., a deionized water rinse and drying process is then optionally carried out in station 12E.

Still referring to FIG. 1, according to an important aspect of the invention, the process wafer with a developed resist (resist pattern) is then transferred to the optical metrology station 16 where selected areas of the resist pattern corresponding to heating zones are probed by incident light to produce scattered light from the resist pattern which is collected over a range of selected wavelengths to form a spectra. The scattered light, need not be, but is preferably collected simultaneously, for example by a conventional reflectometer or ellipsometer, preferably including conventional diode array detectors.

In an important aspect of the invention, the scattered light spectra, collected in digital form from the patterned resist layer (resist pattern), is then passed to the controller 16 for processing and analysis, preferably including dedicated processors for carrying out the processing functions. An ADI diffraction analysis process, referred to herein as optical digital profilometry (ODP), is then preferably undertaken to render the collected spectroscopic digital data (spectra) into 3-dimensional digital information including information representing a 3-dimensional profile of the sampled portion of the resist pattern as a function of resist pattern depth. It will be appreciated that the controller 16 may include incorporated or separate conventional graphical display means and graphical display software for rendering the 3-dimensional profile information of the resist pattern into graphical form with respect to any set of chosen set of reference coordinates. IN an important aspect of the invention, the ODP analysis process preferably includes rigorous wave coupled analysis (RCWA) as is known in the art.

For example, in one embodiment, a test process wafer including patterned adjacent resist lines having a predetermined linewidth and pitch to form a resist grating pattern is first formed by passing the test process wafer through the lithographic track including PEB and development processes to form a resist pattern, referred to herein as a resist grating. One or more scattered spectra are then collected from the resist grating and subjected to diffraction analysis, preferably using RCWA computing methods including simultaneously solving a system of differential equations with appropriate boundary conditions. Preferably, no simplifying or approximating assumptions, for example with respect to boundary conditions, are made prior the performing the RCWA computing algorithm.

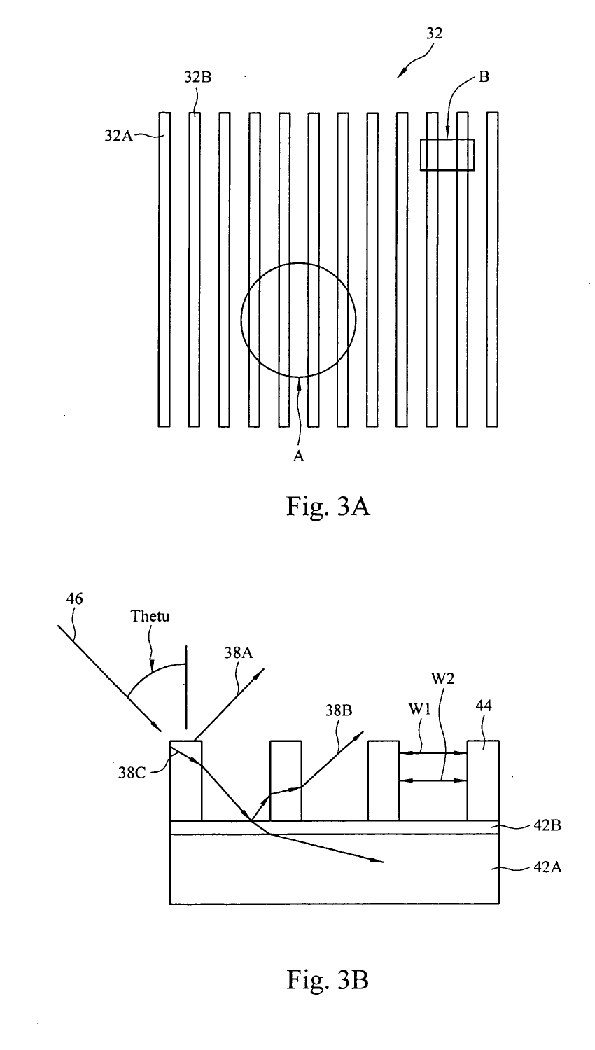

For example, referring to FIG. 3A, is shown an exemplary portion of a resist grating 32, formed by the lithograph track process on an actual or test process wafer. For example, resist lines e.g., 32A, 32B are formed having a predetermined linewidth and pitch. Area A refers to an exemplary probe spot size for incident light from which scattered light spectra is collected according to preferred embodiments, for example having an area of about 50 microns×50 microns, preferably at least greater than about 10 microns×10 microns in diameter. In contrast, area B shows a conventional probe size area for a scanning electron microscope (SEM), for carrying out a conventional ADI process for determining critical dimension variation. For example the SEM probe size area, B, represents a field of view at 150K magnification of about 1 micron×1 micron. Advantageously the spectroscopic ADI ODP method of the present invention includes a surface probe area, e.g., A, larger by about a factor of about 2500:1, and preferably at least greater by a factor of 100:1 compared to a conventional SEM ADI process.

Moreover, the ADI ODP analysis of the present invention advantageously provides 3-dimensional information concerning the dimensions of the patterned resist profile. For example, the ADI ODP analysis is able to determine a CD at an uppermost portion or the resist layer, similar to SEM analysis, but additionally includes information on the resist profile as a function of resist layer depth, for example including CD information on the sidewall portions of the developed resist pattern.

For example referring to FIG. 3B, is shown a cross sectional view of an exemplary process wafer having a substrate portion 42A, an overlying material layer 42B, and a patterned resist layer 44. Incident light from the probing light source of a spectrometer e.g., arrow 46, may be directed onto a probe area of the resist forming an incident angle e.g., theta (e.g., 30 Deg to 90 deg) with respect to the resist surface perpendicular, to improve CD resolution as a function of resist layer depth. It will be appreciated a portion of the incident light is scattered from the surface e.g., 38A after passing through resist portions e.g., 38C, to produce detectable scattered light e.g., 38B. For example, resulting scattered detectable light pathways e.g., 38A, 38B are collected by a conventional detector, e.g., diode array detector, for simultaneous collection of scattered light at different wavelengths. According to ODP analysis, dimensional information on the entire light probed surface portion (in 3-dimensions) of the exposed portions of resist layer 34 may be determined including CD information, e.g., W1 and W2 as a function of resist pattern depth.

It will be appreciated the heating zones of the heating plate may be advantageously created ‘virtually’ by appropriate commands from the controller 18, for example using relational database software, to cluster or map selected heating cells e.g., 22A, 22B and heating elements into heating zones (e.g., 1, 31A, etc.) the number of heating zones only limited by the size of individual heating cells. Representative spectra is collected in each of the process wafer heating zones and stored, for example in a relational database including calculated CD parameters such as CD bias, CD tolerance, 3×sigma, and mean CD over selected measurement points of a wafer surface area as well as the temperatures of the corresponding heating plate heating zones for the PEB process for that particular process or test wafer. A model function relationship between temperature variation of selected heating plate heating zone temperatures and corresponding CD variation of the resist pattern as a function of the temperature variation is then derived by conventional statistical methods including function fitting relationships such as linear and non-linear least squares analysis.

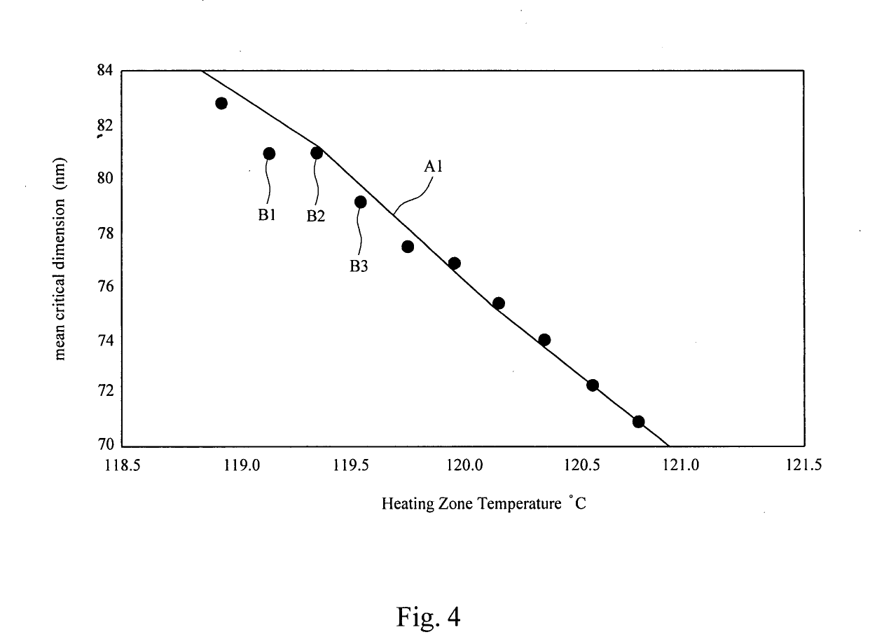

Referring to FIG. 4, an exemplary model functional relationship is shown between variation of a selected CD result and a temperature variation of a selected PEB process heating plate heating zone. For example, the exemplary set of data points e.g., B1, B2, B3 representing mean critical diameter (MCD) values determined from selected wafer surface measurement areas in a selected heating zone according to the ADI ODP method are plotted versus corresponding heating plate heating zone temperatures present in a PEB process. It can be seen that resist profile CD variations of less than 1 nanometer and temperature changes of less than about 0.2° C. can be reliably interpolated by model functional relationship represented by line fit A1. It will be appreciated that function line A1 may be determined by any conventional data or line fitting method including linear and non-linear least squares fitting methods. It will also be appreciated that in processing a test wafer to form a resist grating to develop a model functional relationship, several resist gratings on the same or different test wafers may be formed. In addition, it will be appreciated that corresponding PEB temperatures in the heating plate heating cells/zones during the PEB process may be varied in a predetermined manner to obtain desired temperature step variations to improve a model functional relationship between a heating plate heating zone temperature profile and a CD parameter.

Following obtaining a model functional relationship between heating plate heating zone temperatures and resist CD, the model functional relationship is preferably used to determine a desired temperature profile to obtain desired CD parameters in a subsequent heating process (e.g., PEB) of production process wafers. For example, following lithographic track processing of a production line process wafer including PEB and development to form a resist pattern, the wafer is passed to the optical metrology station 16 and scattering spectra collected and analyzed according to the ADI ODP method to obtain CD profile parameters in 3-dimensions (e.g., CD bias, tolerance, and/or uniformity) including at least a top portion and sidewall portions of the resist pattern. The CD profile information is then analyzed to determine a deviation from a desired CD result by applying (comparing) the previously developed model functional relationship to the CD profile to determine a required (desired) temperature profile (temperatures of the corresponding heating cells/zones) in processing an upstream process wafer in the PEB process to achieve a desired CD profile.

The desired temperature profile is then communicated to the heating plate including heating cells and/or zones to carry out the next heating process (e.g., PEB process). It will be appreciated that the ADI ODP analysis, as well as determining a desired temperature profile and communication to the heating plate at the PEB station, may be automated functions, e.g., by having controller 18 execute programmed instructions as well as communicating with the optical metrology station 16, the PEB station 12C, and the lithographic process track including process wafer selection and transfer functions.

It will be appreciated that a database including a second functional relationship between individual heating cell temperatures and heating zone temperatures may be used to achieve a desired temperature in a heating plate heating zone. For example, a calibration process for heating zone temperature control may be periodically carried out by known methods. Advantageously, however, the method and integrated optical metrology system of the present invention minimizes the need for periodically individually calibrating each heating cell to an absolute temperature to achieve acceptable resist CD control.

For example, since relative changes in resist CD with respect to relative changes in temperature may be readily ascertained and modeled by the model functional relationship, the absolute temperature of the heating cell/zone need not be known. To account for hardware, environmental or lithography process changes, however, the relative changes in temperature of the heating cell/zone are preferably periodically correlated with resist CD variation to update the model functional relationships. In addition, several different model functional relationships may be obtained and stored for use in a particular production line process beforehand, for example where different circuitry patterns having various linewidth, pitch, and density are found to alter the model functional relationship. In addition, it will be appreciated that different model functional relationships may be desirable and necessary when changes in the lithographic track process occur including the type of resist used, the soft-bake temperature and time, PEB temperature and time, as well as changes in the development process, all of which may affect a resist pattern CD variation.

For example, by having a model functional relationship between heating zone temperatures and resist pattern CD parameters, real-time adjustments to the PEB process may be made during the in-line production process to improve resist pattern CD parameters thereby increasing throughput, minimizing downtime for calibration, and increasing wafer yield. For example, the ADI ODP analysis is periodically carried out in-line on production wafers, more preferably, each production wafer is inspected by the ADI ODP analysis and selected CD parameters are compared with the model functional relationship to determine a required heating cell/zone adjustment in real-time and applied to production wafers upstream of the PEB process. Advantageously, unacceptable variations in resist CD may be quickly spotted and corrected in real time by in-line heating zone adjustment to achieve a desired resist CD parameter.

In addition, the lithographic track process may be programmed for interruption by automatic triggers following ADI ODP analysis where it is determined that resist CD parameters are outside a pre-determined acceptance window. In this case, upon triggering an unacceptable result, the lithographic track process may automatically (according to programmed instructions) switched to processing test wafers to perform a calibration process with a resist grating as outlined above to determine a new model functional relationship. Upon obtaining a new model functional relationship, the lithographic track process may be then automatically switched to the processing of production wafers. It will be appreciated that the entire process may advantageously be automated including ADI ODP analysis, production process interruption for calibration, and resumption of the production process.

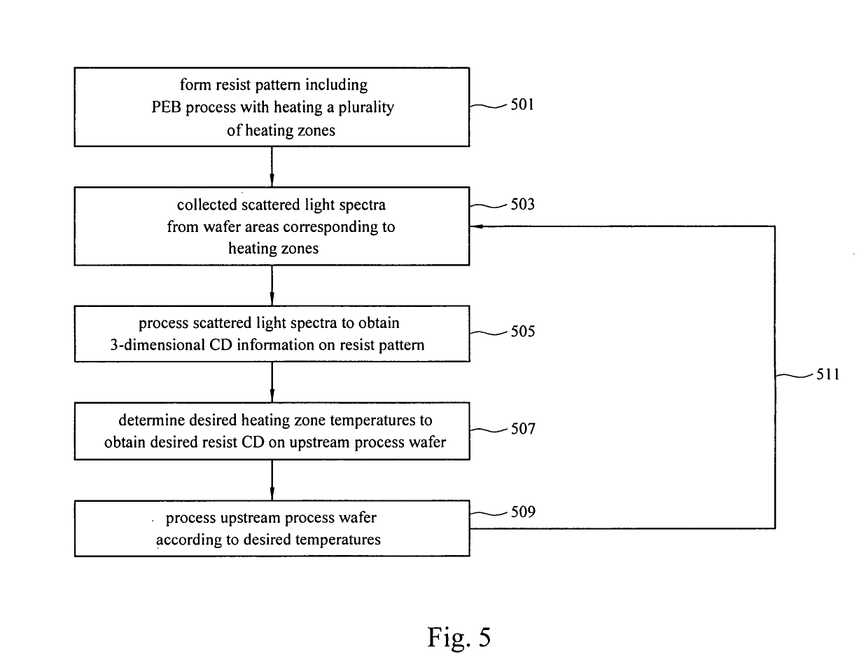

For example, referring to FIG. 5 is a process flow diagram including several embodiments of the present invention. In process 501, a resist pattern is produced on a process wafer including a PEB process where a heating plate comprises a plurality of selectably temperature controllable heating zones. In process 503, spectra comprising scattered light from selected areas of the resist pattern corresponding to PEB heating plate heating zones used to heat the resist is collected and stored. In process 505, the spectra are processed to obtain 3-dimensional resist pattern CD information including at least surface portions and sidewall portions of the resist pattern. In process 507, a determination is made of a desired temperature profile for the plurality of selectably temperature controllable heating zones to achieve a desired resist CD parameter on an upstream process wafer. In process 509, the desired temperatures are produced in the plurality of selectably temperature controllable heating zones and the upstream process wafer treated in the PEB process. As indicated by process directional arrow 511 steps 503 through 509 are then repeated on the upstream process wafer.

Thus, an integrated optical metrology and lithographic system has been present as well as a method for carrying out an integrated lithographic and optical ADI process to improve resist CD parameters as well as improve wafer throughput and yield. Advantageously, the ADI ODP method can be easily integrated in-line in a conventional lithographic track process and advantageously provides 3-dimensional CD information on a patterned resist layer with at least the same resolution as prior art methods providing 2-dimensional CD information, e.g., SEM, TEM. Moreover, the ADI ODP process can obtain 3-dimensional information non-destructively and more quickly compared to prior art processes e.g., SEM, TEM. Advantageously, the ADI ODP analysis can be carried out with few or no simplifying assumptions in a period of time acceptable for an in-line ADI wafer-by-wafer process to improve wafer yield, not practicable with prior art processes. Further, by integrating the ADI ODP process with selectably temperature controllable heating plate heating zones in a PEB process, PEB temperature adjustments to achieve desired resist pattern CD's can be performed in-line and in real time to be applied prior to upstream process wafers thereby increasing wafer throughput and yield. Moreover, the integrated ADI ODP method makes the need for individual absolute temperature calibration of temperature sensors in the heating plate unnecessary by using a model functional relationship to accurately predict in real time CD resist parameters in response to relative temperature changes in the heating plate temperature, thereby increasing flexibility to process variable changes and minimizing down time. Finally, the entire process including production, calibration, and adjustment to environmental or process specific conditions can be readily automated to increase wafer throughput and yield.

The preferred embodiments, aspects, and features of the invention having been described, it will be apparent to those skilled in the art that numerous variations, modifications, and substitutions may be made without departing from the spirit of the invention as disclosed and further claimed below.

What is claimed is:

1. A method for improving a yield and throughput of a lithographic process track comprising the steps of:
providing a first resist layer on a first process wafer;
forming a first resist pattern in the first resist layer comprising a heating process according to a first temperature profile wherein the heating process comprises a plurality of temperature controllable heating zones;
producing and collecting scattered light spectra from the first resist pattern;
processing the scattered light spectrum to obtain 3-dimensional information comprising first resist pattern critical dimensions;
determining a second temperature profile for performing the heating process to achieve targeted resist pattern critical dimensions comprising a second resist pattern on a second process wafer; and,
forming the second resist pattern dimensions comprising the heating process according to the second temperature profile.

2. The method of claim 1, wherein the steps of collecting, processing, and determining are repeated with respect to the second resist pattern.

3. The method of claim 1, wherein the step of forming comprises a lithographic track process transferring and processing wafers according to preprogrammed instructions.

4. The method of claim 1, wherein the step of forming comprises sequentially:
exposing the first resist layer to radiant energy through a mask;
baking the first resist layer according to a post-exposure bake process comprising the heating process; and,
developing the first resist layer according to a development process.

5. The method of claim 1 wherein the heating process comprises a lithographic process selected from the group consisting of a soft-bake process and a post exposure bake (PEB) process.

6. The method of claim 1, wherein the step of producing and collecting light spectra comprises:
probing a selected area of the first resist layer with light; and,
detecting and storing the light scattered from the first resist layer to produce a scattered light spectrum.

7. The method of claim 6, wherein the selected area comprises an area of greater than about 10 microns in diameter.

8. The method of claim 6, wherein the steps of probing and detecting are carried with a spectrometer elected from the group consisting of a reflectometer and ellipsometer.

9. The method of claim 1, wherein the step of processing the scattered light spectra comprises solving a set of differential equations according to rigorous wave coupled analysis (RCWA).

10. The method of claim 1, wherein the step of determining comprises a calibration process.

11. The method of claim 10, wherein the calibration process comprises deriving a model functional relationship approximating a variation of the first resist pattern dimensions with respect to the first temperature profile.

12. The method of claim 10, wherein the first resist pattern comprises a resist diffraction grating.

13. The method of claim 11, wherein the model functional relationship is derived comprising fitting a function to the variation.

14. The method of claim 11, wherein the model functional relationship is derived according to an analysis method selected from the group consisting of non-linear least squares and linear least squares.

15. The method of claim 11, wherein the step of determining comprises an automated process carried out according to preprogrammed instructions comprising;
interrupting a production process comprising the heating process if the first resist critical dimensions fall outside a predetermined window;
triggering the calibration process to obtain a new model functional relationship; and,
resuming the production process comprising upstream process wafers wherein the step of determining comprises the new model functional relationship.

16. The method of claim 1, wherein step of determining a second temperature profile comprises comparing a previously derived model functional relationship approximating a variation in resist critical dimensions with respect to a temperature profile comprising the heating process.

17. The method of claim 1, further comprising the step of communicating according to a set of programmed instructions the second temperature profile to a heating plate comprising the heating process.

18. The method of claim 1, wherein the plurality of temperature controllable heating zones comprise a heating plate comprising a plurality of temperature sensors and heating elements in responsive communication with a controller.

19. The method of claim 18, wherein each of the plurality of temperature controllable heating zones comprises a 2-dimensional geometry selectable by the controller according to programmed instructions.

20. The method of claim 18, wherein the means for producing and collecting the scattered light spectra is in responsive communication with the controller.

21. The method of claim 1, wherein the steps of providing, producing, processing, and determining comprise a lithographic process track functioning according to programmed instructions.

22. A method for improving a yield and throughput of a lithographic process comprising the steps of:
providing a first resist layer on a first process wafer;
forming a first resist pattern comprising a heating process according to a first temperature profile wherein the heating process comprises a plurality of temperature controllable heating zones;
producing and collecting scattered light spectra from the first resist pattern;
processing the scattered light spectrum to obtain 3-dimensional information comprising first resist pattern critical dimensions;
deriving a model functional relationship approximating a variation of the first resist pattern dimensions with respect to the first temperature profile;
repeating the steps of providing, forming, producing, and processing with respect to a second resist layer comprising a production process wafer;
determining a second temperature profile for performing the heating process to achieve targeted resist pattern critical dimensions comprising production process wafers upstream of the heating process according to the model functional relationship; and,
repeating the steps of providing, forming, producing, processing and determining with respect to each of the upstream production process wafers.

23. A lithographic process track system including integrated optical metrology for semiconductor device manufacturing comprising:
a lithographic process track comprising a heating process for forming a patterned resist layer on a process wafer wherein the heating process comprises a heating plate comprising a plurality of temperature controllable heating zones for heating the process wafer according to a temperature profile;
a means for producing and collecting the scattered light spectra from the patterned resist layer;
a means for processing the scattered light spectrum to obtain 3-dimensional information comprising the patterned resist layer pattern critical dimensions; and,
a means for determining a second temperature profile for performing the heating process to achieve targeted resist pattern critical dimensions comprising a second resist pattern on a second process wafer; and,
a means for communicating the second temperature profile to the plurality of temperature controllable heating zones to carry out the heating process on the second resist pattern according to the second temperature profile.

24. The lithographic process track system of claim 23, wherein the heating process, the means for producing and collecting, the means for processing, the means for determining, and the means for communicating are in responsive communication with a controller according to pre-programmed instructions.

25. The lithographic process track system of claim 23, wherein the lithographic process track further comprises:
a radiant energy exposure station for exposing a resist layer to radiant energy through a mask to form the patterned resist layer;
a post-exposure bake station comprising the heating process; and
a developing station for developing the resist layer according to a development process to form the patterned resist layer.

26. The lithographic process track system of claim 23, wherein the means for producing and collecting scattered light spectra comprises:
a light source for probing a selected area of the patterned resist layer with light; and,
a plurality of detectors for detecting and collecting the light scattered from the patterned resist layer to produce a scattered light spectrum.

27. The lithographic process track system of claim 26, wherein the selected area comprises an area of greater than about 10 microns in diameter.

28. The lithographic process track system of claim 23, wherein the means for producing and collecting comprise a spectrometer selected from the group consisting of a reflectometer and ellipsometer.

29. The lithographic process track system of claim 23, wherein the patterned resist layer comprises a calibration resist pattern forming a diffraction grating.

30. The lithographic process track system of claim 23, wherein the means for determining comprises a set of preprogrammed instructions for;
interrupting a production process comprising the heating process if the first resist critical dimensions fall outside a predetermined window;
triggering the calibration process to obtain a new model functional relationship; and,
resuming the production process comprising upstream process wafers wherein the step of determining comprises the new model functional relationship.

31. The lithographic process track system of claim 23, wherein the heating plate comprises a plurality of temperature sensors and heating elements in command and responsive communication with a controller.

32. The lithographic process track system of claim 31, wherein each of the plurality of temperature controllable heating zones comprises a 2-dimensional geometry selectable by the controller according to programmed instructions.

33. The lithographic process track system of claim 31, wherein the controller is in communication with the means for producing and collecting the scattered light spectra according to programmed instructions.

34. The lithographic process track system of claim 23, wherein the means for processing the scattered light spectra comprises one or more processors for executing programmed instructions.

35. The lithographic process track system of claim 34, further comprising a means for displaying the resist pattern critical dimensions.

36. A lithographic process track system including integrated optical metrology for semiconductor device manufacturing comprising:
a lithographic process track comprising a heating process for forming a patterned resist layer on a process wafer wherein the heating process comprises a heating plate comprising a plurality of temperature controllable heating zones for heating the process wafer according to a temperature profile in communication with a controller;
a means for producing and collecting the scattered light spectra from the patterned resist layer in communication with the controller;
a means for processing the scattered light spectrum to obtain 3-dimensional information comprising the patterned resist layer pattern critical dimensions in communication with the controller; and,
programmed instructions executable by the controller for determining a second temperature profile for performing the heating process to achieve targeted resist pattern critical dimensions comprising a second resist pattern on a second process wafer; and,
wherein the controller is in communication with the plurality of temperature controllable heating zones for communicating and executing the second temperature profile to carry out the heating process on the second resist pattern according to the second temperature profile.
